(19) United States
(12) Patent Application Publication
(10) Pub. No.: US 2024/0394330 A1
(43) Pub. Date: Nov. 28, 2024

(54) Solving Differential Equations with Deep Learning

(71) Applicant: Microsoft Technology Licensing, LLC, Redmond, WA (US)

(72) Inventors: Philipp Andre WITTE, Seattle, WA (US); Ranveer CHANDRA, Kirkland, WA (US); Sverre BRANDSBERG DAHL, Redmond, WA (US); Mehmet Kadri UMAY, Redmond, WA (US); Riyaz PISHORI, Sammamish, WA (US); Russell Joseph HEWETT, Woodinville, WA (US)

(73) Assignee: Microsoft Technology Licensing, LLC, Redmond, WA (US)

(21) Appl. No.: 18/202,416

(22) Filed: May 26, 2023

(51) Int. Cl. G06F 17/13

(52) U.S. Cl. CPC G06F 17/13

(57) ABSTRACT

This document relates to solving challenges associated with solving partial differential equations (PDEs) via numerical simulations relating to natural or physical systems. One example obtains input data relating to a physical system and partitions tensors of a neural network across multiple parallel processors. The example distributes the input data across multiple parallel cloud processing resources for numerical simulations involving partial differential equations to produce corresponding output data. The example trains the neural network across the tensors of the multiple parallel processors with the input data and the output data to produce a surrogate model of the partial differential equations. The example can receive subsequent input data and generate corresponding subsequent output data utilizing the surrogate model.

### BACKGROUND

Simulating natural or physical systems provides useful insights into nature and associated technological solutions. However, these simulations can involve daunting amounts of data and calculations.

### SUMMARY

This description generally relates to overcoming challenges associated with solving partial differential equations (PDEs) via numerical simulations relating to natural or physical systems. One example obtains input data relating to a physical system and partitions tensors of a neural network across multiple parallel processors. The example distributes the input data across multiple parallel cloud processing resources for numerical simulations involving partial differential equations to produce corresponding output data. The example trains the neural network across the tensors of the parallel processors with the input data and the output data to produce a surrogate model of the partial differential equation. The example can receive subsequent input data and generate corresponding subsequent output data utilizing the surrogate model and without performing another simulation.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The Detailed Description is described with reference to the accompanying figures. In the figures, the left-most digit(s) of a reference number identifies the figure in which the reference number first appears. The use of similar reference numbers in different instances in the description and the figures may indicate similar or identical items.

FIGS. 1, 2, 3, 4A, 4B, and 15 illustrate example hybrid parallelism systems, consistent with some implementations of the present concepts.

FIGS. 5A-12 illustrate hybrid parallelism graphs, consistent with some implementations of the present concepts.

FIGS. 13 and 14 show hybrid parallelism flowcharts of example methods or techniques, consistent with some implementations of the present concepts.

### DETAILED DESCRIPTION

### Overview

This patent addresses challenges associated with solving partial differential equations (PDEs) via numerical simulations relating to natural or physical systems. The concepts can be applied to many different physical systems, such as fluid and reservoir scenarios. Physical systems involving fluid can relate to wave properties and/or fluid flow, such as aerodynamic shape design for wings, such as employed on wind turbines and/or airplanes. Reservoir scenarios can involve movement (or lack thereof) of one substance, such as a fluid in another substance (e.g., media), such as porous rock. Example scenarios include numerical reservoir simulations for carbon capture and storage (CCS), simulations of methane plumes for leak detection, etc.

Many of these applications require a large number of (sequential) numerical simulations for forecasting, scenario testing, optimal control and inverse problems or uncertainty quantification. Conventionally, numerical simulations are based on well-established numerical methods such as the finite difference, finite volume, or finite element method. Running commercial-scale simulations using these methods is computationally very expensive, as it requires solving large linear or non-linear systems of equations using iterative methods. For this reason, solution times for solving a single differential equation oftentimes lies in the range of multiple hours to days, which strongly limits the usage of simulations for the targeted applications. For example, optimizing the number and locations of CO₂ injection wells for CCS requires hundreds to thousands of sequential numerical simulations, each of which take many hours to run, making this problem pragmatically infeasible for many applications, such as commercial-scale applications.

The present concepts provide a technical solution in the form of a cloud-based workflow/pipeline for training neural networks to solve PDEs via deep learning. Solving PDEs with neural networks (Scientific Al/ML) makes it possible to reduce the simulation times from multiple hours to fractions of a second and thus allows using neural network based surrogate models in downstream applications that require multiple and in many cases thousands of sequential simulations. However, several challenges must be addressed to scale deep learning-based PDE solvers to commercial problem scales.

First, neural networks for solving PDEs are trained with supervised learning. The training data consists of pairs of input and output data. The inputs are PDE coefficients, boundary/initial conditions, and/or control parameters and the outputs are the solutions of the respective PDE (as a function of space and/or time). To obtain the output data, users must run an existing numerical simulator 100 s to 1,000 s of times and store the simulation output for training. This requires access to high performance computing (HPC) infrastructure.

The inputs and outputs for the neural networks are high-dimensional solutions of differential equations with millions of variables per training sample. Training such neural networks exceeds the current memory capabilities of existing compute resources, such as graphical processing units (GPUs) and thus requires tensor parallelism (domain decomposition) for distributing neural networks and the input/output data across many processing units, such as GPUs. In some cases, both the training and the inference pipelines should be tightly integrated into existing cloud platforms. For example, downstream applications should be able to access the trained models and run inference pipelines for different inputs or applications.

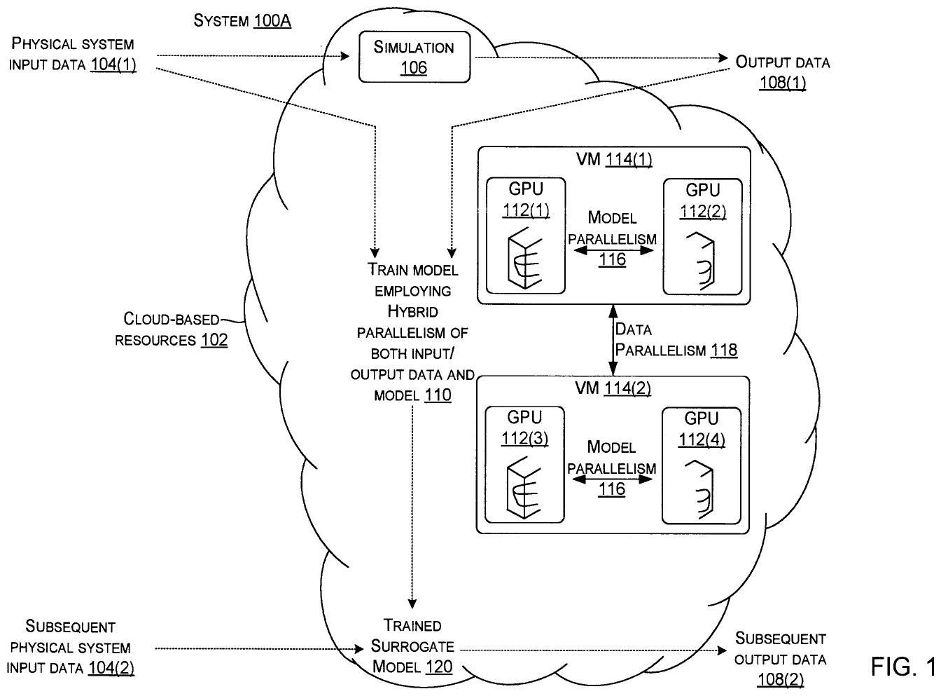

Introductory FIG. 1 shows an example system 100A that can implement the present hybrid parallelism concepts. The system 100A includes cloud-based resources 102. The cloud-based resources 102 can receive input data relating to a physical system (e.g., physical system input data 104(1)). The present concepts apply to many physical systems and examples are described above and below. For purposes of explanation, assume that this physical system relates to aerodynamic shape design. The cloud-based resources can perform a simulation 106 on the physical system input data 104 to produce output data 108. The simulation 106 involves solving a partial differential equation on the given input data and thus can be viewed as a ‘partial differential equation-based simulation.’ This simulation 106 can be very resource intensive. Various existing simulations can be employed. With existing techniques that would be the end of the process.

With these existing techniques, the simulation process would simply be repeated each time more (e.g., subsequent) input data 104 is received). As mentioned above, the simulation process would likely need to be repeated thousands of times with each time requiring multiple hours to complete. However, with existing techniques, even when multiple hours are dedicated to each simulation, the size of the simulation is limited based on the resource limitations of a single computing device that processes the input data.

With existing techniques, each time more (e.g., subsequent) physical system input data was received, the partial differential equation simulation would be repeated to produce output data. However, the partial differential equation simulation can be very resource intensive in both the numbers of compute resources employed and the duration they are employed. The present implementations can facilitate the partial differential equation simulation by distributing the input data across multiple parallel cloud processing resources to produce the corresponding output data.

Ultimately, unlike existing methods, the present implementations do not repeat the partial differential equation simulation each time physical system input data 104 is received. Instead, the present implementations utilize the input data 104(1) and the output data 108(1) from a limited number of simulations to train a neural network model at 110. Training the neural network model is made feasible by employing hybrid parallelism of both the input/output data and the neural network model.

The hybrid parallelism involves partitioning tensors of the neural network across multiple processors, which are manifest as GPUs 112 or other processor types. Other processor types could be employed, such as deep learning processors, tensor processing units, etc. In FIG. 1 the multiple GPUs are represented as GPU 112(1) and GPU 112(2) of virtual machine 114(1) and GPU 112(3) and GPU 112(4) of virtual machine 114(2). Tensors can be defined as an array of numbers that transform according to certain rules under a change of coordinates. In the context of solving differential equations with neural networks, (input) tensors represent the simulation parameters (coefficients, sources, and sinks, etc.) and (output) tensors represent the solution of the PDE. Partitioning the tensors (e.g., partitioning the neural network model across processors on different physical or virtual machines) so that no single machine has to store the entire neural network model can be termed ‘model parallelism’ 116. Similarly, distributing input data 104(1) and the output data 108(1) across different devices of the cloud resources 102 so that no single device has to process all of the input and output data can be termed ‘data parallelism’ 118.

The neural network model is trained across the tensors of the multiple GPUs 112 with the input data 104(1) and the output data 108(1). The trained neural network can be viewed as a trained surrogate model 120 to the partial differential equation simulation 106. The trained surrogate model 120 can offer immense compute resource saving (e.g., orders of magnitude) compared to running the partial differential equation simulation on subsequent input data 104(2) to produce subsequent output data 108(2). Thus, the term ‘surrogate’ is used relative to the trained surrogate model to convey that the trained surrogate model can function in place of the simulation 106 to produce output data. Stated another way, the trained surrogate model can receive input data and generate output data that is equal to, or very closely approximates, output data that would have been produced via a PDE-based simulation. This is a noteworthy technical solution in that the trained surrogate model 120 can produce subsequent output data 108(2) from subsequent input data 104(2) in less than a second as opposed to tens or hundreds of hours for the simulation 106 while using much less compute resources than the simulation. Previous attempts to generate trained surrogate models for solving large-scale 3D PDEs at industry-relevant scales have failed. The present hybrid parallelism concepts provide a technical solution to this problem that can handle extremely large compute requirements and extremely large data loads via hybrid data and model parallelism.

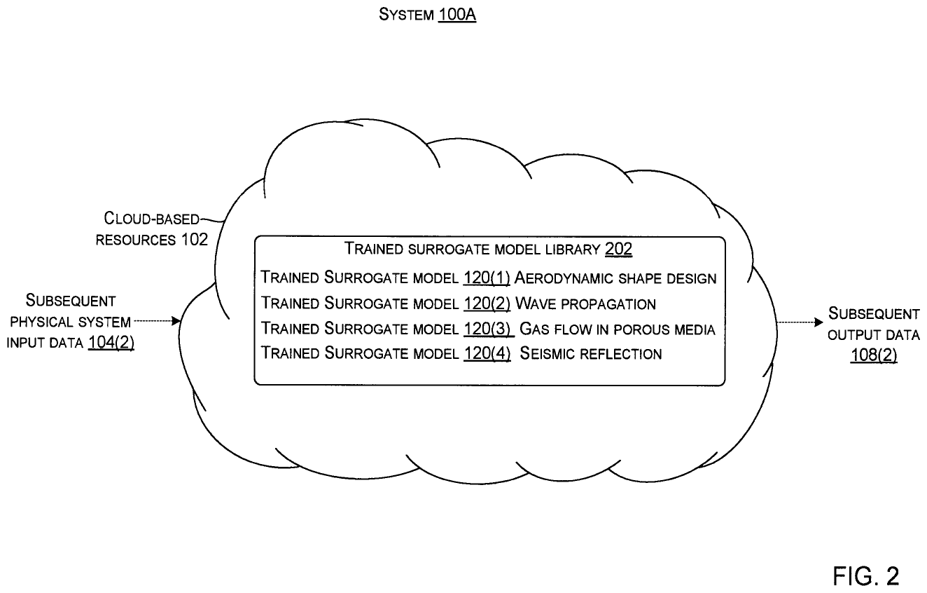

Note also, the trained surrogate model 120 can be re-useable beyond the present physical system instance upon which the surrogate model is trained. Further, the concepts explained relative to FIG. 1 can be used to generate many different trained surrogate models. These aspects are described below relative to FIG. 2.

FIG. 2 shows system 100A that now includes a trained surrogate model library 202. The trained surrogate model library 202 includes trained surrogate models 120 relating to various physical systems including for example, aerodynamic shape design, wave propagation, gas flow in porous media, and seismic reflection, etc. The trained surrogate model 120(1) relating to aerodynamic shape design was described above relative to FIG. 1. Other trained surrogate models 120(2)-120(4) in the trained surrogate model library 202 can be trained in a similar manner to the description relating to FIG. 1. Now when subsequent physical system input data 104(2) is received that relates to one of the trained surrogate models 120, no simulation is needed. Instead, the subsequent physical system input data 104(2) can immediately be run through the corresponding trained surrogate model 120 to generate the corresponding subsequent output data 108(2). The corresponding trained surrogate model can accommodate variations (e.g., material parameters) relating to subsequent input data to customize the output data. The variations can be accommodated via PDE coefficients that reflect the material parameters. For instance, in relation to the physical system relating to gas flow in porous media, the input data could include PDE coefficients for the type of gas and/or the porosity of the media. The trained surrogate model 120(3) can accommodate these variations to provide accurate output data 108(2) for the physical system without retraining and/or additional simulations.

This configuration further increases the advantages of the trained surrogate models 120 by increasing the number of times the trained surrogate models can be used. From a user perspective, results can be obtained much faster and cheaper than with existing techniques. Stated another way, the amount of compute resources and/or elapsed time to receive output data is reduced by several orders of magnitude compared to running a simulation. This technical advantage is magnified in that many professional fields process hundreds or thousands of sets of data to achieve the desired level of information about the physical system. This technical advantage is magnified further by the fact described above that once a surrogate model is trained it can be re-used for similar scenarios. For instance, if trained surrogate model 120(3) is trained with ‘gas A’ in media having ‘porosity X,’ the trained surrogate model can be used to produce output data for ‘gas B’ in media having ‘porosity Y.’ Thus, additional time and compute resources are saved compared with having to train the model to each scenario (e.g., variations of a physical system).

Other entities are attempting to build Al-based simulators that involve a framework for training physics-informed neural networks for solving PDEs. However, in contrast, the framework of the present implementations is based on supervised training, which includes the data simulation step to generate training data. Stated another way, the initial input and output data becomes the supervised training data for training the surrogate model. In addition, the framework under development by other entities allows users to train models with data parallelism only, but not model parallelism. Still other entities are attempting to build Al-based numerical simulators, e.g., for simulating CO₂ flow using supervised training. However, these attempts have been unsuccessful in scaling to industry-relevant problem sizes (e.g., CO2 flow simulations for commercial projects) because they do not employ the present hybrid-parallelism (model+data parallelism) concepts.

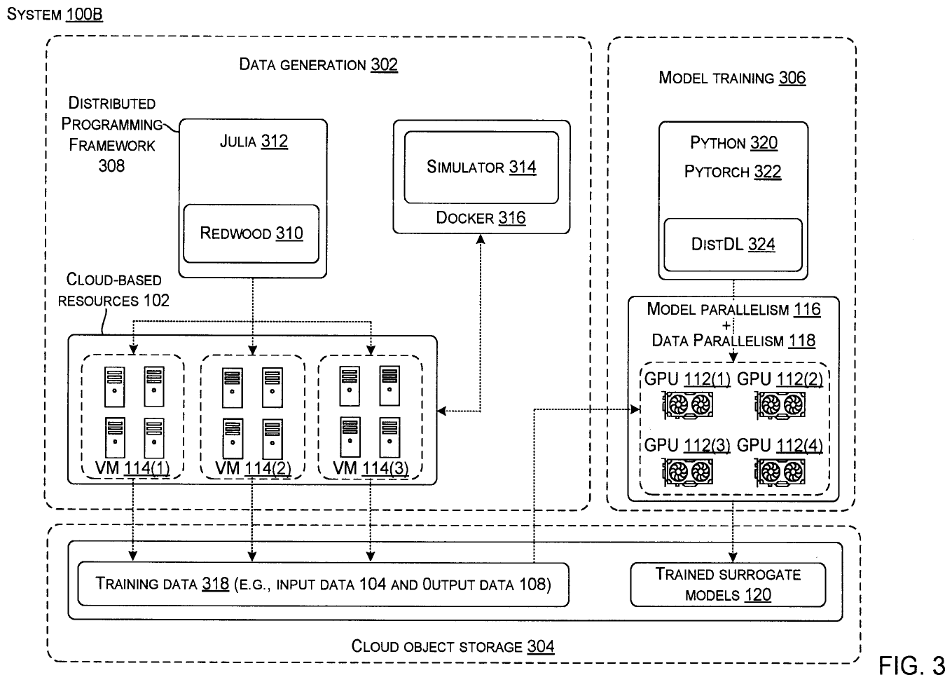

To summarize, the hybrid-parallelism concepts introduced above solve partial differential equations with deep learning, which makes it possible to reduce simulation times by multiple orders of magnitude and unlock scientific methods that typically rely on large numbers of sequential simulations, such as optimization and uncertainty quantification. Two of the largest challenges of adopting scientific AI for industrial problem settings is that training datasets must be simulated in advance and that neural networks for solving large-scale PDEs exceed the memory capabilities of current compute resources, such as GPUs. The present concepts introduce distributed programming application program interfaces (API) for simulating training data in parallel on the cloud and without requiring users to manage the underlying high-performance computing (HPC) infrastructure. One version of these APIs is termed ‘Redwood’ and is described in detail below beginning relative to FIG. 3.

In addition, the description shows that model-parallel deep learning based on domain decomposition allows scaling neural networks for solving PDEs to commercial-scale problem settings and achieves above 90% parallel efficiency. Combining the present cloud API for training data generation and model-parallel deep learning, large-scale neural networks can be trained for solving various complex simulations, such as the 3D Navier-Stokes equation and simulating 3D gas flow in porous media.

For the gas flow example with CO₂ representing the example gas, the description includes simulating a training dataset based on a commercial carbon capture and storage (CCS) project and training a neural network for CO₂ flow simulation on a 3D grid with over two million cells that is five orders of magnitudes faster than a conventional numerical simulator and 3,200 times cheaper.

Solving PDEs with numerical methods plays an important role in many industrial fields such as aerodynamic shape design, exploration seismology, finance, carbon capture and storage (CCS), and/or renewable energies. Commercial and open-source simulation packages are conventionally based on the finite difference (FD), finite volume (FV), or finite element method (FEM) analysis, but recently there has been a growing interest in solving PDEs with various machine or deep learning (ML/DL) methods. Deep learning in the context of numerical simulations, which falls under the umbrella of scientific AI/ML or SciML, promises to reduce the simulation time of PDEs by several orders of magnitude compared to traditional solvers or simulate phenomena for which the underlying PDE is unknown. These factors make deep learning-based approaches attractive for applications that require many sequential simulations such as inverse problems and uncertainty quantification (UQ).

For many commercial-scale applications, numerical simulators must be able to solve time-dependent PDEs on large-scale meshes with millions of grid points and therefore most simulation packages use techniques from high-performance computing (HPC) to scale to large-scale problem sizes on HPC clusters. Current state-of-the-art methods for solving PDEs with deep learning, however, have so far been limited to either 2D problem sizes or small-scale 3D problems, with typical mesh sizes that lie below or around one million grid points. A significant reason for this limitation is the amount of available GPU memory, as memory demand for training neural networks scales with the size of the input and output data. Solving PDEs with deep learning (DL) at large problem sizes beyond the memory capacity of a single GPU requires model parallelism rather than data parallelism.

A second important challenge of training large-scale deep learning surrogate models is the simulation of training data. In scenarios that involve training networks for solving PDEs that generalize to different boundary/initial conditions or sets of PDE coefficients (e.g., material or control parameters, such as properties of the gas and/or porosity of the media), scientific Al approaches are based on supervised learning. Training data for supervised learning consists of pairs of input data (boundary/initial conditions, PDE coefficients) and output data (solutions of the PDE as a function of space and time) and therefore requires running many conventional numerical simulations prior to training. For large-scale industrial applications, such as reservoir simulation, users must run 100 s to 1,000 s of simulations for training data generation, each of which potentially takes multiple hours to run on a multi-core machine.

Simulating training data for scientific ML applications therefore requires access to HPC infrastructure, which is only available to a limited number of researchers (typically at national and corporate labs). Cloud computing offers an alternative to on-premise HPC clusters and is publicly available, thereby providing an opportunity to democratize access to HPC infrastructure. However, running HPC workloads in the cloud involves significant administrative challenges, as users are responsible for creating and managing virtual HPC clusters themselves. This leads to a significant amount of complexity that makes it difficult to scale deep-learning based surrogate models for solving PDEs to industry-scale problem sizes.

The present description provides a technical solution that addresses these two outlined challenges and scales deep neural networks for solving PDEs to industry-scale problem sizes. To achieve this, notable objectives include technical solutions relating to: 1. A software package that simplifies running HPC workloads in the cloud, with an emphasis on simulating training data for scientific AI workloads; 2. Explanations for why current approaches to parallelism in deep learning are inadequate for scaling scientific AI models to industrial-scale applications and showing that model parallelism-based domain decomposition is a more promising approach that achieves high levels of parallel efficiency (above 90%); 3. Demonstrate that addressing the above challenges enables applying scientific AI to a real-world reservoir simulation problem and training the largest deep learning-based numerical simulator to date.

### Example Implementation

For purposes of explanation, an example implementation described below relates to fluid flow (in this case the fluid is CO2 in a supercritical state) in porous media, which in this case is rock. This implementation works with other fluids and porous media that have various properties. The concepts explained relative to this implementation are equally applicable to other physical systems. The inventive aspects are implemented in a cloud-native workflow (e.g., on cloud-resources) but could be implemented on other high performance computing systems. In this case, the cloud resources relate to Azure cloud, but are equally applicable to other cloud resources, such as Amazon Web Services, IBM Cloud, and/or Google Cloud, among others.

In this example, the cloud resources are utilized for training deep neural networks to solve PDEs in the context of energy applications (reservoir simulation, methane plume dispersion, etc.). The described workflow consists of three main components: parallel training data simulation; model and data parallelism of neural networks for solving PDEs; and model delivery. Each of these components addresses some of the challenges outlined above and is addressed below with reference to FIGS. 1 and 2.

### Parallel Training Data Simulation

The training data generation (e.g., input data 104 and output data 108) requires running 100 s to 1,000 s of numerical simulations. To accommodate this large amount of data and processing, the present implementations use parallel cloud computing resources to run the numerical simulations 106 on cloud-based resources 102. The training data can then be stored on the cloud-based resources 102 (e.g., in cloud object storage) for training. A large number of simulations can be launched in parallel using cloud-based resources 102, such as Azure HPC schedulers, such as Azure Batch, Singularity, Azure Kubernetes (AKS) and/or Azure Cycle Cloud. Alternative resources include AWS Batch, AWS EC2 clusters, AWS EKS or GCP Batch, GCP Compute Engine and Google Kubernetes Engine (GKE). The input into this step consists of a large number (1,000 s) of different simulator configurations (such as input models, boundary/initial conditions, control parameters). Each parallel task runs an existing numerical simulator with the given configuration and then writes the simulated data to the cloud-based resources 102, such as Azure object store. Possible simulators that are used in this step depend on the application and include open-source simulators for CO₂ flow (Open Porous Media, GEOSX) or commercial simulators from other parties (e.g., Eclipse, Intersect), among others.

### Model Parallelism of Neural Networks for Solving PDEs

Recall that as mentioned above, the input data 104 and output data 108 for the neural network is too large to train the neural networks with data parallelism only. The present concepts include a hybrid parallelism solution based on a combination of model parallelism 116 and data parallelism 118. Some implementations of the combination of model parallelism 116 and data parallelism 118 of model neural networks can be based on existing deep learning architectures for solving PDEs, such as Fourier Neural Operators (FNOs), convolutional neural networks (U-Nets, Residual Nets) or transformer-based networks. Two specific implementation algorithms for the hybrid parallel FNO are provided below. For training, tensors of the neural network (weights, biases, inputs, outputs, hidden states/activations) are partitioned across multiple GPUs, typically across GPUs of a single virtual machine (VM) (e.g., across eight Nvidia A100 VMs in this example). In addition, data parallelism can be utilized to process individual data samples from a (mini-) batch on separate virtual machines. Stated another way, samples of the input data can be split across separate nodes and the network itself can be split across GPUs within a node/VM to train the surrogate model 120.

Algorithm 1 description

```
  1. Broadcast encoder weights from GPU 0 (e.g., the first GPU)
to all GPUs (across all VMs).
  2. Input data is distributed along batch and x dimension. The
encoding is computed on each GPU individually (no communication
required).
  3. Send data tensor through n FNO blocks (defined in
Algorithm 2). In some implementations, n=4, though other values can be
employed.
  4. Broadcast decoder weights from GPU 0 to all GPUs (across
all VMs).
  5. As in the encoder, apply decoder on each separate GPU.
```

Algorithm 2 description (note Algorithm
2 expands on Algorithm 1 step 3)

| | |
|---|---|
| 1. | Input data is distributed along batch and x dimension. |

| | |
|---|---|
| a) | Compute 3D Fourier transform along non-partitioned |
| | dimensions (i.e., y, z, t). |
| b) | Truncate high frequencies of dimensions y, z, t. |
| c) | Re-partition the data tensor to distribute along the |
| | batch and y dimension. |
| d) | Compute Fourier transform and truncation along x |
| | dimension. |

| | |
|---|---|
| 2. | Weights are defined on one VM and are distributed to its |

GPUs along the k_y dimension.

| | |
|---|---|
| a) | Broadcast weights from GPUs of one VM to GPUs of |

all VMs.

| | |
|---|---|
| 3. | Compute spectral convolution on each GPU (no |

communication required).

| | |
|---|---|
| 4. | Apply steps from (1.) in reverse order: |

| 1. | Zero-padding and inverse Fourier transform |
|---|---|
| along x. | |
| 2. | Repartition from y to x dimensions (keep |
| distribution along batch dimension fixed). | |
| 3. | Zero-padding and inverse Fourier transform |

along y, z, t dimensions.

Algorithm 1 Architecture of model + data-parallel FNO

# Broadcast encoder weights stored on master to all workers
W_{c}_{ᵢ}_{c}_{ₒ}^{encoder} ← BW_{c}_{ᵢ}_{c}_{ₒ}^{encoder}
# Linear encoder and activation [symbol]
← σ( [symbol] W_{c}_{ᵢ}_{c}_{ₒ}^{encoder})
# FNO blocks (i=1,2,3,4) [symbol]
← σ(fno_block ( [symbol] [symbol] ))
# Broadcast decoder weights to all workers
W_{c}_{ᵢ}_{c}_{ₒ}^{decoder} ← BW_{c}_{ᵢ}_{c}_{ₒ}^{decoder}
# Linear decoder and activation [symbol]
← σ( [symbol] W_{c}_{ᵢ}_{c}_{ₒ}^{decoder})

Algorithm 2 Architecture of distributed FNO block

# Distributed FFT and freq. truncation [symbol]
← [symbol] ₓ [symbol] ₓ [symbol] _{x→y} [symbol] _{yzt} [symbol] _{yzt} [symbol]
# Broadcast weights to data-parallel partitions [symbol]
← [symbol]
# Spectral convolution [symbol]
← [symbol] [symbol]
# Padding and inverse FFT [symbol]
← [symbol] _{yzt}^{τ} [symbol] _{yzt}^{τ} [symbol] _{x→y}^{τ} [symbol] ₓ^{τ} [symbol] ₓ^{τ}

[symbol]

### Notations Relating to Algorithm 1 and Algorithm 2

X_{bcxyzt}: Data tensor of dimensions batch, channel, space, x, y, z, time. Distributed dimensions are underlined.

W_{c}_{ᵢ}_{c}_{ₒ}^{encoder}, W_{c}_{ᵢ}_{c}_{ₒ}^{decoder}: Encoder/decoder weights of dimensions channel in, channel out.

W_{c}_{ᵢ}_{c}_{ₒ}ₖ_{ₓ}ₖ_{_{y}}ₖ_{_{z}}ₖ_{ₜ}ⁱ: Complex weights of i^{th} FNO block of dimensions channel in, channel out, spatial wave numbers, x, y, z, temporal frequency.

[symbol] : Broadcast operation. In the backward pass, the adjoint of the broadcast operator is used (i.e sum-reduce).

[symbol] ₓ: Truncation/subsampling operator. Subscripts indicate the dimension along which the operator acts. In the backward pass, the adjoint of truncation is used (i.e. zero padding).

[symbol] ₓ: Fourier transform along indicated tensor dimension.

[symbol] _{x→y}: Repartition operator. Changes the dimensions along which a tensor is distributed as indicated by the subscript.

### Model Delivery

The trained surrogate model 120 can be made available for various uses. Some implementations can provide access to the trained surrogate model 120 via the trained surrogate model library 202 of FIG. 2. In some implementations, the trained surrogate model library 202 can be achieved via Azure Machine Learning (AML) or Microsoft Cloud for Industry (MCI) or similar products, such as AWS Sagemaker and Google Colab. In this case, the trained surrogate models 120 can be registered in the AML registry. The registered models can be accessed from the AML registry by downstream applications or outside services (e.g., client platforms). Other alternatives to deliver models to users/clients can be based on Azure Industry platforms, such as the Energy Platform.

### Technical Advantages

It is possible to reduce the turn-around time for data generation by leveraging HPC resources and elastic compute on cloud resources, such as Azure for training data simulation. The turn-around time can be reduced to the time it takes to run a single simulation. For instance, all simulations can be run in parallel on Azure even if a particular scenario involves simulating 1,000 s of pairs of training data. Once the neural network model is trained with the training data to solve the PDE, simulations can be run in fractions of a second and thus reach substantial time savings for sequential simulations. This allows deploying the trained network for downstream applications that require 100 s to 1,000 s of simulations such as optimal control or optimization.

Solving PDEs for commercial-scale energy applications such as reservoir simulations requires that networks scale to large-scale input and outputs with millions of features/variables per training sample. Hybrid parallelism for deep learning enables training such large-scale neural networks on cloud-based resources, such as Azure, whose memory requirements exceed the available memory of single GPUs. Combining data and model parallelism takes advantage of high-bandwidth interconnect within an Azure VM for tightly coupled communication (model parallelism), while distributing less communication-intensive workloads across multiple VMs (data parallelism).

FIG. 3 shows system 100B that expands upon some of the concepts introduced above relative to FIG. 1. System 100B is organized into a data generation component 302, a cloud object storage component 304, and a model training component 306. Data generation component 302 includes a distributed programming framework 308. In this case the distributed programming framework 308 is manifest as ‘Redwood’ 310. Redwood 310 is implemented in Julia programming language 312. Data generation component 302 also includes simulator 314 (that performs the simulation 106 of FIG. 1). The simulator 314 operates in a docker 316. Redwood 310 provides a Julia API for running simulators 314 on high numbers, such as thousands, of virtual machines 114. Training data 318 (e.g., input data 104(1) and corresponding output data 108(1)) is generated on multiple virtual machines 114 of cloud-based resources 102. The training data 318 is stored on cloud object storage component 304. The cloud object storage component 304 can be configured for storing unstructured data. In the example described below, cloud object storage component 304 is manifest as Azure binary large object (BLOB) storage. Compute resources/products/services from other cloud-based providers can alternatively be employed to those described above.

Model training 306 is accomplished via suitable languages, such as Python 320 and/or Pytorch 322, employing distributed deep learning (DistDL) 324. Model training 306 involves training the model employing hybrid parallelism of both the training data 318 and the model 110 across multiple GPUs 112 of multiple virtual machines 114. Model training 306 is accomplished by streaming the training data 318 stored on cloud object storage component 304 to the multiple parallel operating GPUs 112.

System 100B provides an architecture to scale scientific AI to industrial-scale problem sizes involving at least two technical challenges. First, users without access to traditional HPC clusters should be able to generate simulated training data. Second, scientific AI training should be enabled for neural network models and high-dimensional scientific data sets with millions or billions of degrees-of-freedom. To achieve the former, batch computing services such as Azure Batch can satisfy the necessary requirements for running large-scale HPC workloads in the cloud and they can be made accessible to scientists through abstractions that expose these services as distributed programming frameworks to the user. To solve the second challenge, domain decomposition achieves much better levels of concurrency and scaling than alternate model parallel approaches, and even a relatively small number of GPUs suffices for training industrial-scale simulators. These two main contributions that enable the scalability of scientific AI to industry-scale problems are summarized below.

As introduced above, Redwood 310 (e.g., Redwood.jl) is an open-source package on Julia 312 for running scientific computing workloads in the cloud without having to manage the underlying infrastructure. This package enables users to run both Julia and third-party simulators 314 on the cloud for simulating training data 318 in the context of scientific AI.

Pipeline parallelism is not well suited for training an FNO-based AI simulator. However, domain decomposition reaches above 90 percent parallel efficiency (on up to 8 Nvidia A100 GPUS), for example. This achievement involves improving the parallel FNO implementation by adding support for Nvidia collective communications library (NCCL) and reducing overall communication volume.

These contributions can be leveraged to train the largest surrogate models (e.g., trained surrogate models 120) for solving PDEs to date. A first example involves training an FNO for simulating turbulent flow around a sphere on a spatial-temporal grid of 130×130×130×84 grid points (140 million solution points, in total) using 3,200 simulated training samples. A second example involves training an FNO for simulating CO₂ flow on the Sleipner geomodel. The Sleipner geomodel is a real-world reservoir simulation benchmark from the world's first industrial CCS project. 1,600 training examples are simulated to train an FNO to predict CO₂ flow on the original simulation grid of 262×118×64 grid points for 86 time steps—a total of 170 million predicted variables and an order of magnitude larger than the current largest AI simulator trained on GPUs.

To summarize, the architecture of system 100B is configured to scale scientific AI to industry-scale applications, among other uses. This architecture includes an API (e.g., Redwood 310) on the selected programming language (e.g., Julia 312). The API allows parallel training data generation in the cloud and a model-parallel FNO implementation based on DistDL (e.g., distributed deep learning for PyTorch) 324. In relation to the data generation component 302, Redwood 310 provides a technical solution in the form of a distributed programming framework in the Julia language that enables users to run simulators written in Julia or binary code on cloud-based resources 102, such as the Azure cloud. While other programming languages can be used in other implementations, the Julia programming language is employed in some implementations because Julia is designed to support numerical computing with an emphasis on high performance and multi-platform support via just-in-time compilation. This model-parallel FNO implementation is written in Python 320. The performance can be further enhanced/optimized for scalability on a single Nvidia DGX (up to eight A100s) by adding NCCL support to DistDL and/or by reducing data communication in the FNO implementation. The next two sections describe each architecture component in more detail, starting with Redwood 310 and the Julia 312 framework for parallel training data generation on Azure.

### Redwood Architecture

Redwood 310 is a distributed programming framework built on top of Azure's first-party batch computing service Azure Batch. One technical solution provided by Redwood is to relieve users from managing HPC infrastructure on the cloud, while at the same time preventing users from having to interact with platform-or cloud-specific user/REST APIs. Instead, users interact with Redwood's distributed programming macros that closely resemble Julia's existing macros for cluster-based HPC. As used here ‘cluster based’ means that conventionally, users first need to administer an HPC cluster with cloud services such as Azure Cycle Cloud or Kubernetes and then use an HPC scheduler such as SLURM or PBS to request parallel resources on the cluster.

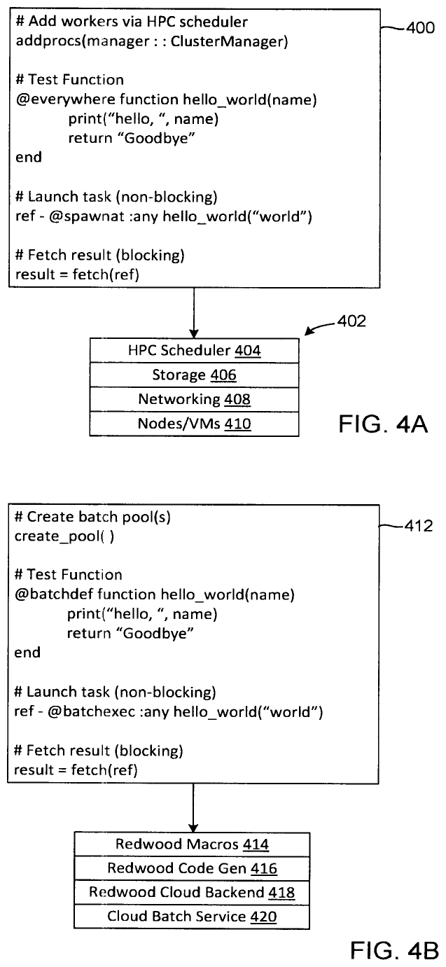

FIGS. 4A and 4B collectively illustrate examples of additional functionality provided by Redwood. Both FIGS. 4A and 4B are running a hello-world example. FIG. 4A shows Julia's conventional distributed programming model 400 on an HPC cluster 402. FIG. 4B shows a clusterless HPC solution with Redwood. FIG. 4A employs HPC scheduler 404, storage 406, networking 408, and Nodes/VMs 410. FIG. 4B shows model 412 employs Redwood macros 414, Redwood code gen 416, Redwood cloud backend 418, and cloud batch services 420.

As shown in FIG. 4A, Julia's native distributed programming framework is primarily based on task parallelism using one-sided communication statements. The main primitives that enable this style of communication are remote function calls and remote references. To remotely execute a function on parallel workers, users first tag their function with the @everywhere macro, which makes the function known to the parallel workers and then execute it via the @spawnat macro. This macro executes the code on a specified remote worker and returns a reference to its function output, which can be copied to the master by calling the fetch function.

As shown in FIG. 4B, Redwood provides Redwood macros 414 and functions for executing Julia code through cloud batch services 420, such as Azure Batch. This means that instead of running a parallel Julia session on top of a (user-managed) HPC cluster, users execute remote function calls from their laptop or a single cloud node through Azure Batch. The main difference to the conventional approach is that the main Julia program is not connected to any of the worker nodes directly and instead, remote function calls are scheduled and executed via cloud batch services 420 (e.g., Azure Batch). Redwood provides macros for remotely executing functions on one or multiple workers, for fetching remote references, as well as for broadcasting variables. This makes it possible to convert a conventional distributed Julia program to one that runs on top of Azure Batch with minor changes to the code. The current Redwood version supports Azure Batch and additional/other backends (e.g., for AWS or GCP) can be supported as well.

Redwood's core functionality is the execution of tagged Julia functions as parallel Azure Batch jobs and/or tasks. The @batchexec macro creates a closure around the executed expression, serializes the function's abstract syntax tree (AST), and submits a batch job to Azure using the Azure Batch user API (which the Redwood user never interacts with directly). More specifically, calling a function with the @batchexec macro involves the following steps: (1) parsing of function input arguments,(2) splitting of expressions into parallel tasks (for more than one task),(3) replacing of return statements with the serialization of output arguments to object storage,(4) serializing the ASTs of previously tagged expressions and of the executed expression and uploading them to cloud storage, (5) making API calls to create batch jobs/tasks, and (6) returning a control structure with a reference to the (future) function output.

The remote Azure Batch workers each run a light-weight Redwood runtime, which downloads and de-serializes the uploaded ASTs and compiles and runs them on the local architecture. By default, Redwood 310 executes functions on the smallest Azure virtual machines (VMs) 114, but users can specify any other VM types that are supported by Azure Batch, including the HBv3 series with InfiniBand interconnect, 120 CPU cores and 448 GB of memory that specifically targets HPC workloads, among others. Redwood's default behavior is to execute remote function calls as individual tasks that each run on a single node and cannot communicate with each other. However, users can also enable multi-node parallelism and execute function calls that run across multiple VMs, e.g., by combining Redwood with Julia's MPI interface.

### Redwood Performance

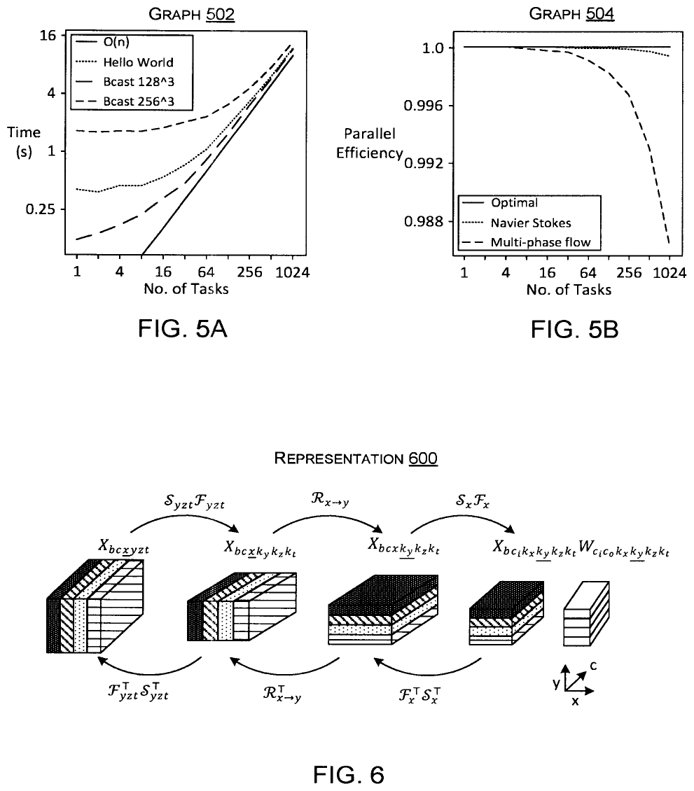

FIGS. 5A and 5B collectively show results of an investigation that shows how long it takes to submit a job with an increasing number of tasks by executing a Julia function n times in parallel (using the parallel mapping function). Submitting tasks to Azure Batch involves Redwood's code generation, as well as the serialization and upload of code and function arguments. FIG. 5A shows a graph 502 that provides a baseline that measures the task submission time of an increasing number of invocations of the hello-world example from FIG. 4A. The results in FIG. 5A show that for a small number of function invocations, task submissions are dominated by the code generation and upload time, which happens only once, regardless of how many tasks are submitted. However, for more than 16 tasks, the task submission time is dominated by the time it takes to upload the function argument, which is uploaded n times, as function arguments can be unique to each function invocation. Eventually, the task submission time scales linearly with the number of tasks.

Next, the tests show how long it takes to broadcast a 3D Julia array to an increasing number of tasks (running on separate VMs). Redwood's broadcast macro uploads data once to the object store and returns a reference to the data that can be passed as a function argument in place of the original array. Each task then calls the fetch function on the reference to copy the data from blob storage to the worker. The time to submit a job with a small number of tasks is now higher than for the hello-world example, as it includes the time to broadcast the array. However, once a certain number of tasks is reached, the submission time is again dominated by the upload time of the function arguments and thus eventually reaches linear behavior. Broadcasting bigger arrays further increases the job submission time for a small number of tasks and shifts the point at which linear behavior sets into a larger number of tasks.

The experiments show that, in the worst case, job submission time grows linearly with the number of tasks. One question of interest is whether it is worth optimizing the job submission time, e.g., using recursion. Optimizing the task submission time to reduce latency is important for serverless functions, in which the actual function execution time is small (in the range of milliseconds or seconds). However, Redwood specifically targets long-running HPC workloads that run on the order of multiple minutes to hours, so job submission times of, for example, 16 seconds for 1,024 tasks are treated as acceptable. To illustrate this, the parallel weak scaling efficiency is computed for the data generation of the numerical examples. To simulate the training data for the two AI simulators, 3,200 instances of the 3D Navier-Stokes equation and 1,600 instances of the 3D two-phase flow equation are solved. The average task runtime for each scenario is 15 minutes and 6.8 hours, respectively. Running these simulations with Redwood is embarrassingly parallel with the only serial component being the task submission. As the task submission time is small in comparison to the overall runtime, both examples reach a high parallel efficiency above 99 percent as shown in graph 504 of FIG. 5B.

### Neural Network Architecture

Some of the present implementations employ Fourier Neural Operators (FNOs) as the base architecture for the Al-driven simulator, as FNOs have shown strong performance on a variety of PDEs such as the Navier-Stokes equations or multi-phase flow. Parallel FNO implementations based on domain decomposition have been previously employed. This description introduces a modification to the original implementation and includes the algorithm of the (updated) parallel FNO implementation in this section. This implementation is based on parallel primitives from the DistDL library. For FNOs, these implementations rely on the tensor-parallel broadcast and re-partition primitives. The broadcast primitive is a partition-aware generalization of the classical parallel communication primitive and the re-partition primitive is a generalization of the all-to-all communication pattern for arbitrarily high-dimensional Cartesian data.

First, the description establishes the mathematical notation. Capital letters represent multi-dimensional tensors and subscripts are dimension labels. Six-dimensional data tensors X_{bcxyzt} are utilized with dimension batch size b, channel c, spatial dimensions x, y, z and time t. Dimensions in Fourier space are labeled kₓ, k_{y}, k_{z}, kₜ. Caligraphic capital letters are linear operations and subscripts indicate the dimensions along which they operate. In this case, [symbol] ₓ is a Fourier transform along the x dimension and [symbol] _{yzt} represents subsampling or truncation along dimensions y, z, and t. Operator [symbol] is the broadcasting operation, which copies a tensor from the master worker to all other workers. R_{x→y} is the re-partition operation whose subscripts represent the distributed dimensions before and after partitioning. The partitioned tensor dimension is underlined. For tensor multiplications, the Einstein summation notation from PyTorch is utilized. Multiplications along dimensions that appear both in the inputs and the outputs are element-wise multiplications and otherwise multiplications are followed by a summation. For example, the operation Y_{bc}_{ₒ}_{xyzt}=X_{bc}_{ᵢ}_{xyzt}W_{c}_{ᵢ}_{c}_{ₒ}_{xyzt} performs an element-wise multiplication along dimensions xyzt (which appear in all three tensors) and a multiplication followed by a sum along the input channel dimension cᵢ (which only appears on the right-hand side). Letters W_{c}_{ᵢ}_{c}_{ₒ}_{xyzt} are network weights.

The model-parallel FNO implementation based on this notation closely follows the architecture of the original FNO. The network consists of an encoder that increases the channel dimension of the input through a one-by-one convolution. This is followed by a number of FNO blocks and a decoder that brings the channel dimension down to the desired number of output channels. In the model-parallel FNO version, the input tensor X is distributed across the first spatial dimension x. As the convolutions in the encoder and decoder do not sum along this dimension, the method simply needs to broadcast the encoder/decoder weights during the forward pass and perform the tensor multiplications independently on each worker.

FIG. 6 shows a representation 600 of distributed spectral convolution of the FNO block. Briefly, the technique first computes the FFT along the non-partitioned dimensions and truncates the high frequency. Then data is re-partitioned and the technique computes the FFT along the final dimension. After multiplication with the learnable weights, the technique repeats the operations in reverse order using the adjoints of the linear operators.

The FNO blocks perform spectral convolutions in the Fourier domain and compute 4D Fourier transforms (FFT) of the input along the spatial-temporal tensor dimensions (xyzt). As in the original FNO, most frequencies are truncated after the FFT to reduce the number of learnable weights. In the model-parallel version, the input tensor is initially partitioned along the spatial x dimension, so the 4D FFTs cannot be directly computed. First, a 3D FFT is computed along the non-partitioned dimensions and frequency truncation is applied along those dimensions to reduce the data size. Next, the re-partition operator is applied, which distributes data along the y dimension and allows computation of the final FFT along the x dimension. The tensor multiplication with the weight tensor is an element-wise multiplication in the spatial-temporal dimensions (kₓk_{y}k_{z}kₜ) and summation only occurs along the (non-partitioned) channel dimension. Each worker therefore maintains its own portion of weights and no communication is required for the spectral convolution itself. For the inverse FFT, the same steps as before are applied in reverse order, using the adjoint (conjugate transpose) of the linear operators.

Previously published model-parallel versions use a two-dimensional partitioning scheme and perform frequency truncation after the re-partitioning. This results in a total of four re-partition operations per FNO block, during each of which the full tensor X is communicated. Two re-partition operations are performed per FNO block, during each of which a tensor is communicated whose size has been truncated along three dimensions. These examples truncated around 80 percent of the frequencies in each dimension, thereby reducing the amount of communicated data by a factor of 160 per re-partition operation.

### Network Performance

The performance evaluation of the parallel FNO implementation is motivated by the goal to scale AI simulators to industry-scale problem sizes. The current state of the art is advanced without scale model-parallelism across hundreds of GPUs on a large network, but rather reaching high parallel efficiency on a small number of GPUs on a single node with high-bandwidth GPU interconnect. The current version of DistDL uses an MPI communication backend, which includes support for cuda-aware MPI. However, to achieve the best possible performance, an NCCL backend is implemented for DistDL primitives. As NCCL is optimized for Nvidia's GPU topologies, this ensures the techniques can take optimal advantage of Nvidia's NVLink interconnect. Scaling tests are performed on a single Azure ND96amsr VM with eight Nvidia A100 GPUs, each with 80 GB of RAM.

The selected problem setup occupies about 80% of the memory on a single GPU and uses randomly generated input data of batch size one. The spatial dimension of the overall problem can be increased by using additional GPUs, while keeping the problem size per GPU fixed (i.e., weak scaling). Both the size of the input data and the number of weights can be increased, so both the memory footprint, as well as number of floating-point operations (FLOPs) per GPU stays constant.

Using data with a batch size of one precludes the use of data parallelism and ZeRO, both of which require at least a batch size equal to the number of GPUs. This leaves pipeline parallelism, which allows partitioning the network and data across multiple GPUs, although it does not provide any concurrency for a batch size of one.

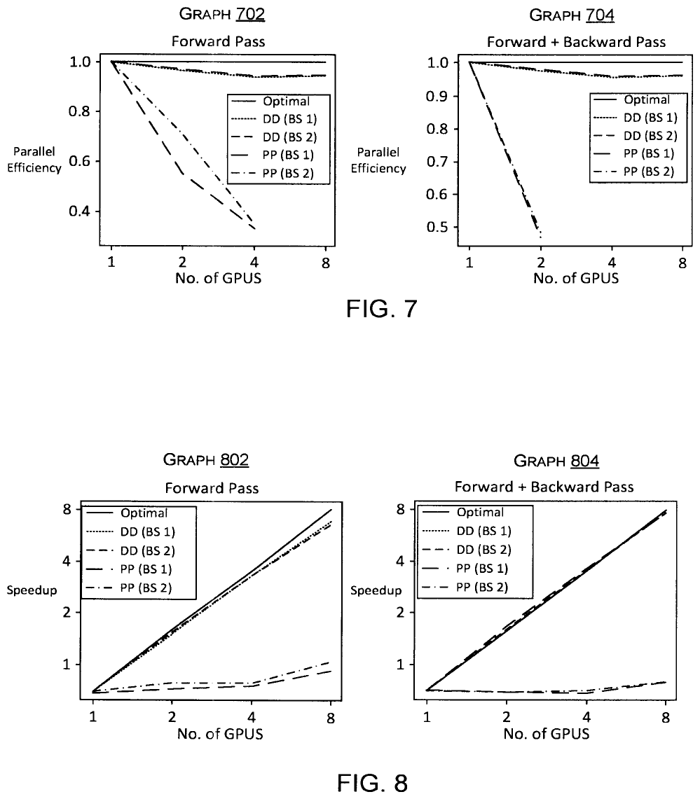

FIG. 7 shows graph 702 relating to forward passes and graph 704 relating to forward and backward passes. FIG. 7 shows weak scaling of model-parallel FNOs with pipeline parallelism (PP) and domain decomposition (DD), using data with batch sizes (BS) of one and two. Both the memory footprint and the number of FLOPs per GPU are constant. Error bars indicate the 95% confidence interval over 16 runs.

The results of weak scaling experiments confirm pipeline parallelism, which reaches 50% parallel efficiency on two GPUs for the pipeline parallel (PP) FNO and 25% on four GPUs (i.e., no concurrency). In contrast, the FNO based on domain decomposition (DD) achieves above 90% parallel efficiency in the forward pass and above 95% in forward-plus backward pass.

On eight GPUs (the maximum number of GPUs in a current single virtual machine), pipeline parallelism runs out of memory, even though the problem size per GPU is fixed, which indicates that PyTorch's pipeline parallelism module suffers from a memory overhead. When computing the backward pass as well, pipeline parallelism runs out of memory for more than two GPUs. As pipeline parallelism relies on larger batch sizes to achieve concurrency, the scaling experiments are repeated for a batch size of two as well (by making the spatial dimension smaller so that the memory footprint stays the same).

On two GPUs, pipeline parallelism now achieves in fact some level of concurrency (parallel efficiency larger than 50%), but on four GPUs the efficiency decreases again (likely because the batch size is smaller than the number of GPUs). Domain decomposition reaches high parallel efficiency in both cases, thereby demonstrating the strengths of this approach, which does not rely on a specific batch size to reach high levels of concurrency.

While strong scaling is less relevant for training neural networks, as memory usage usually dictates the number of GPUs required, it is important for speeding up inference time. This description therefore investigates the strong scaling behavior of pipeline parallelism and domain decomposition as well. The same problem setup is utilized as in the previous experiment, but keeps the overall data dimensions fixed so that the problem size per GPU shrinks. Once again, high performance and nearly linear scaling is reached with domain decomposition and generally poor performance with pipeline parallelism as shown in FIG. 8.

FIG. 8 shows strong scaling of model-parallel FNOs with pipeline parallelism (PP) and domain decomposition (DD) using varying batch sizes (BS) in relation to graphs 802 and 804. The memory footprint and the number of FLOPs on each GPU is reduced according to the total number of GPUs. Error bars indicate the 95% confidence interval over 16 runs.

### Applications

The description below relates to training two Al-based numerical simulators for solving large-scale 3D PDEs with deep learning. These Al-based numerical simulators are trained using two novel tools presented in this description. The present concepts advance the current state of the art in scientific AI by a factor of eight in terms of the number of predicted variables. The predicted variables correspond to the grid or mesh size and number of predicted time steps. For both examples 4D FNOs are trained that predict spatial-temporal solutions of PDEs with more than 140 million output variables per sample. Once trained, these AI surrogate models are valuable in downstream applications such as optimization or uncertainty quantification.

### Turbulent Flow

The first example involves training an FNO-based surrogate model for simulating turbulent flow around a sphere by solving the 3D Navier-Stokes equation. In this dataset, the location of the sphere is varied in three-dimensional space, which leads to different flow patterns, depending on the location and distance of the sphere from the model edges (using Dirichlet boundary conditions). 3,200 data pairs are generated that consist of input and output data. Each input is a 3D binary map that indicates the location of the sphere and each output is a 4D tensor of the simulated vorticity of dimensions 130×130×130×64 (three spatial dimensions plus time). As FNOs require that inputs and outputs have the same dimensions, the input binary map is repeated along the time dimension.

The training data is simulated with WaterLily.jl, an open-source Julia package for solving the 2D and 3D Navier-Stokes equations with the geometric multigrid method. A Julia function is implemented that takes the location of the sphere as input, solves the 3D Navier-Stokes equation with WaterLily, and outputs the scalar vorticity as a function of space and time (i.e., as a 4D tensor). Redwood is employed to create a batch pool of 1,000 Azure VMs (E4 s v3 with 4 vCPU cores) and run 3,200 simulations to generate the training data.

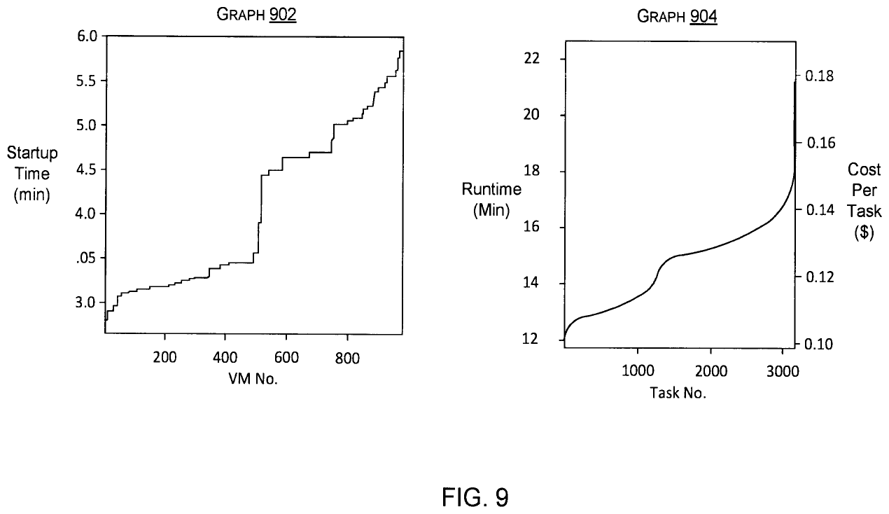

FIG. 9 shows graphs 902 and 904. Graph 902 shows the time it takes to launch (e.g., startup time) the 1,000 VMs. About half of the VMs are available after 3.5 minutes and most remaining VMs are available after 6 minutes, in this example. Note that Azure Batch starts scheduling tasks as soon as the first VMs become available, so users do not have to wait for all VMs to spin up first.

Graph 904 shows the runtime of each of the 3,200 tasks and the cost of simulating each training sample. The average simulation time is 15 minutes per sample and the cost for generating the full dataset on

Azure is $396 with on-demand VMs and $158 using spot VMs. Each task writes its simulated training pair to Azure Blob storage using Zarr, for example. Zarr is a Python package for storing N-dimensional arrays on various storage backends, including cloud object storage. Each training sample has a size of 536 MB and the total data set is 1.6 TB (in uncompressed form).

The FNO is trained on a single Azure ND96amsr VM, the same VM as used in the performance evaluation. Training is performed for 50 epochs using a batch size of two, which is the maximum possible batch size before running out of memory. 2,800 of the data samples are used for training and validation and 400 samples are saved for testing. The training time per epoch is around 30 minutes and total training time is close to 24 hours (on-demand price of $786 and spot price of $393). As the input for the FNO is partitioned along the first spatial dimension, each GPU reads its corresponding chunk of the data from blob storage during the first training epoch. The full dataset (1.6 TB) approaches the limits of the VM's CPU memory (1.9 TB). This allows the training data to be cached on a local NVMe drive from which the data is re-read during subsequent training epochs.

Network performance on the validation and test data is listed in Table 1.

TABLE 1

| | MSE | MAE | R2 |
|---|---|---|---|
| Navier-Stokes: Validation | 0.0552 | 0.5851 | 0.9714 |
| Navier-Stokes: Test | 0.0507 | 0.5587 | 0.9734 |
| CO₂ flow: Validation | 1.1104 · 10⁻⁴ | 0.0866 | 0.9453 |
| CO₂ flow: Test | 1.1603 · 10⁻⁴ | 0.0952 | 0.9487 |

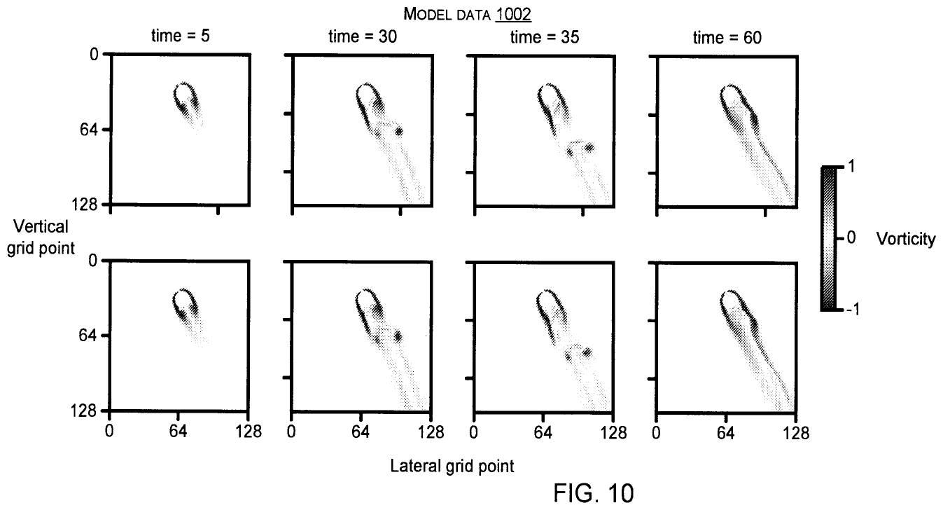

FIG. 10 shows model data 1002 as several 2D slices of the predicted data at different time steps in comparison to the data simulated with WaterLily. (The model data shown in FIG. 10 is a black/white/greyscale representation of actual color model data). The sphere location shown in the example was drawn from the test dataset and was not seen by the network during training. The FNO is able to predict the vorticity in 0.1 seconds on 8 A100s, whereas the numerical simulation with WaterLily takes around 15 minutes on 4 CPU cores. Taking into account the cost differences of the VMs arrives at a cost of 6.25 cents per simulation with WaterLily on the E4 s VM and 0.09 cents per simulation using the FNO on the ND96amsr VM. Accounting for the cost of data generation and training, the FNO amortizes that cost after 19,188 simulations and will save money for any additional simulations. As downstream applications, such as optimizations, potentially require tens of thousands of (sequential) simulations, this opens up both cost and time savings.

### CO₂ Flow

The second example involves training an FNO for simulating CO₂ flow in an industry-scale carbon capture scenario. For simulating the training data, the Sleipner 2019 benchmark model is utilized for simulating the training data. The Sleipner 2019 benchmark model is a real-world geological model for 3D numerical reservoir simulations. Sleipner is the world's first commercial CCS project and is located off the coast of Norway in the North Sea. The Sleipner 2019 benchmark model simulates the CO₂ plume behavior as observed during the project, which used a single CO₂ injection well. Training the FNO is accomplished by simulating training data with the original Sleipner geomodel, but using multiple concurrent CO₂ injection wells that vary spatially. At test time, CO₂ flow is predicted at new well locations for up to four wells. Note that the original model is not sub-sampled and the technique uses the full simulation grid of size 262×118×64 for training and testing. The FNO is trained to predict the CO₂ saturation history for 86 time steps, which results in a total of 170 million output variables.

For training, 1,600 data samples are simulated with the Open Porous Media (OPM) simulator, an open-source reservoir simulator written in C++ and based on the finite volume method. The simulator configuration and parameters from the Sleipner benchmark are used with the OPM simulator. The only changes relate to the number and location of injector wells. Even though OPM is not written in Julia, Redwood can still be used for the training data generation. A docker image is set up with OPM and the Redwood runtime, which is automatically deployed to the VMs by Azure Batch. A Julia function is written in Redwood that runs the simulator on each worker, reads the simulated output back into Julia, and stores it in blob storage for training. As before, a batch pool with 1,000 Azure VMs (E8 s with 8 vCPUs) is used.

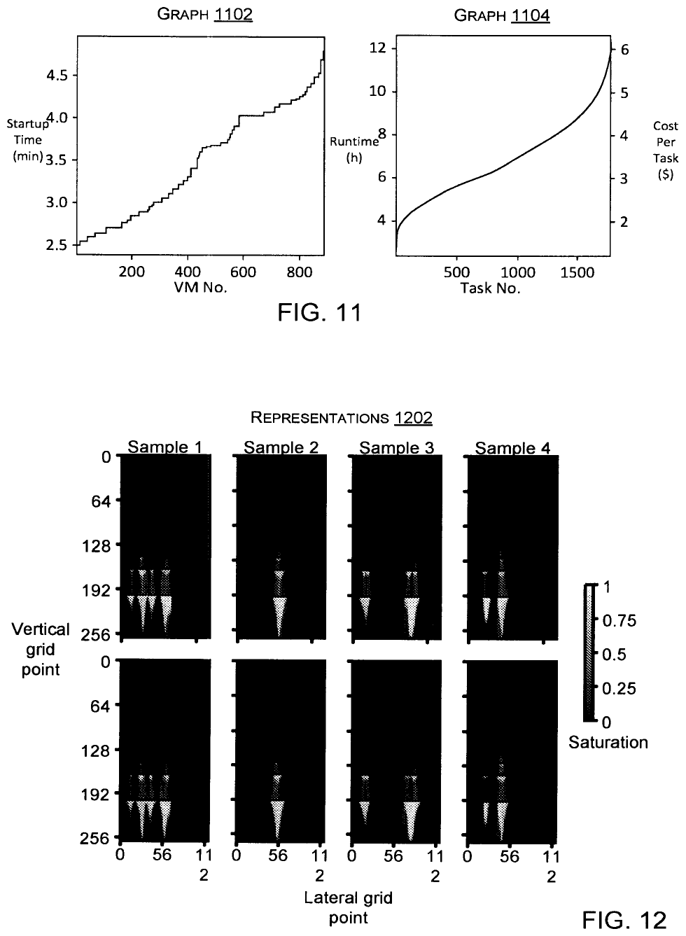

FIG. 11 shows graphs 1102 and 1104 of the VM startup times and runtime, respectively, of each task. Compared to the Navier-Stokes example, the simulation time per sample is much larger (6.5-6.8 hours on average) and the total cost for data generation is $5,487 with on-demand VMs and $2,194 with spot VMs.

Each of the 1,600 training pairs consists of a 3D binary map that indicates the locations of the injection wells (repeated along the time dimensions) and the simulated CO₂ saturation history as a 4D tensor of space and time. As before, a single Azure node is trained with 8 A100s for 50 epochs and a batch size of two. The training time per epoch is around 20 minutes and the total training time is 17 hours ($557 on-demand and $279 spot price).

FIG. 12 shows representations 1202 of CO₂ saturation at the final simulation time step as predicted by different well scenarios as modeled with OPM (top row) and the FNO (bottom row). FIG. 12 shows several 2D slices (from the 4D volumes) at the final time step for four different well scenarios as modeled with OPM (top row) and the FNO (bottom row). (The model data shown in FIG. 10 is a black/white/greyscale representation of actual color model data). Simulations with the trained FNO take around 0.12 seconds (on the ND96amsr VM), whereas the average simulation time with OPM on the E8 s VM is 6.8 hours. Adjusting for the difference in VM prices, this results in $3.4 per simulation with OPM and 0.11 cents per simulation with the FNO (a factor of 3,200). Considering the cost of training data generation and training itself, the FNO breaks even after running 1,848 simulations and is 3,200 times cheaper for any additional simulations. Considering the large number of possibilities to place up to four wells in the model (over 12 billion combinations), the FNO provides a fast and low-cost surrogate model for optimizing well placement or uncertainty quantification.

Model parallelism is more tightly coupled than data parallelism because data is communicated at each neural network layer and not just to synchronize gradients at the end of a forward-backward pass. The obtained high parallel efficiency on up to 8 GPUs relies on the high-bandwidth NVLink interconnect between GPUs on a single node (up to 600 GB/s). The combined memory of 8 A100 s is sufficient to predict 84 time steps on a simulation grid with 2 million cells, which is a total of 170 million output variables. If the same configuration is used to solve a stationary PDE (or predict only one time step at a time), 512³ grid points in 3D or 12,000² points in 2D can be processed. These problem sizes are sufficient for many commercial settings. However, there are cases that require even larger meshes, which in turn require scaling model-parallel networks across nodes and likely leads to lower parallel efficiency. A potential limitation of the current implementation is the sole use of model/domain parallelism and training with a small batch size of two. Training with larger batch sizes requires hybrid parallelism models, similar to the strategy from the Turing NLG model, a transformer that combines ZeRO data parallelism with tensor decomposition and pipeline parallelism.

Both Redwood and DistDL (for implementing the model-parallel FNO) raise the abstraction level for users, who do not have to interact with cloud vendor-specific REST APIs or message passing APIs. Nevertheless, implementing model parallelism with DistDL involves considerably more code changes than implementing data or ZeRO parallelism in PyTorch (tens of lines versus a few lines). To implement model/tensor parallelism for the FNO, it is necessary to partition each tensor of the network manually, including weights/biases, input/output tensors, and hidden states. There are many possibilities for choosing a tensor partitioning scheme and the choice of partitioning significantly influences the amount of data communication and performance. For example, the FNO implementation distributes tensors along one of the spatial-temporal dimensions, which only requires the communication of hidden states during the 4D FFT and iFFT, but not during the encoder and decoder. However, partitioning data tensors along the channel dimension is also possible, in which case the FFTs become embarrassingly parallel, but the encoder and decoder require communication.

Scientific AI has the potential to address challenging scientific computing problems that rely on expensive numerical simulations, but scaling to commercial problem sizes is the main roadblock in adopting this technology for industry applications. The present concepts introduce an API for simulating large-scale training datasets in the cloud, which in combination with model parallelism for deep learning, enables training commercial-scale simulators for solving the Navier-Stokes and two-phase flow equations, among others. Experimentation shows that using only commodity cloud VMs and a small number of GPUs, the largest AI simulator to date can be trained on a real-world reservoir simulation benchmark to unlock scientific AI for commercial-scale settings.

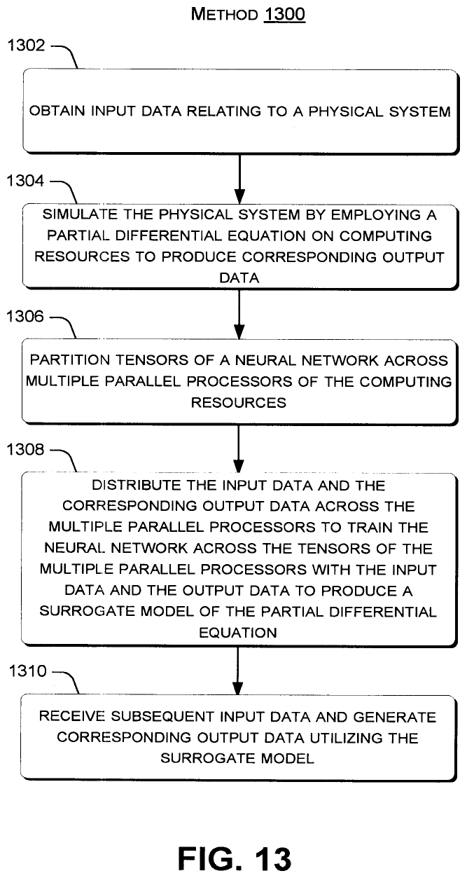

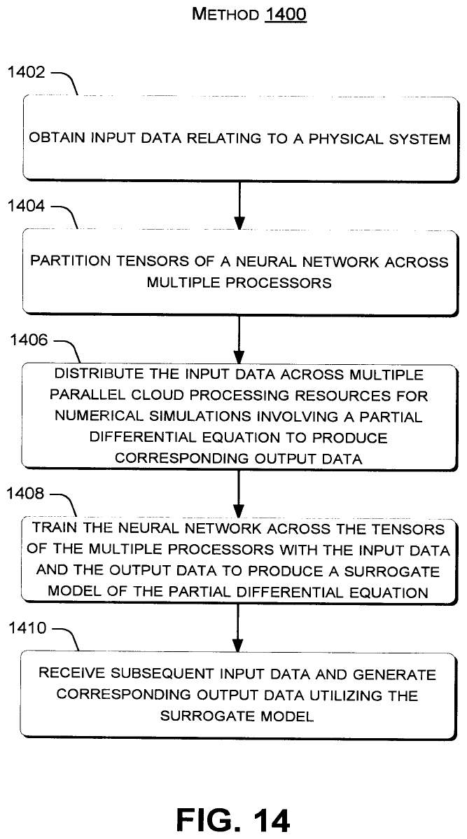

Several implementations are described in detail above. FIGS. 13 and 14 show flowcharts of two additional example methods.

FIG. 13 relates to method 1300. At block 1302, the method can obtain input data relating to a physical system.

At block 1304, the method can simulate the physical system by employing a partial differential equation on computing resources to produce corresponding output data. The partial differential equation can entail a single partial differential equation or multiple partial differential equations.

At block 1306, the method can partition tensors of a neural network across multiple parallel processors of the computing resources. In some cases, the partitioning tensors of a neural network across multiple processors can entail partitioning the tensors across multiple graphics processing units (GPUs). In other cases, the partitioning tensors of a neural network across multiple processors entails partitioning the tensors across multiple deep learning processors or tensor processing units.

At block 1308, the method can distribute the input data and the corresponding output data across the multiple parallel processors to train the neural network across the tensors of the multiple parallel processors with the input data and the output data to produce a surrogate model of the partial differential equation. In some cases, distributing the input data and the corresponding output data across multiple parallel cloud processing resources can entail distributing the input data and the corresponding output data across multiple virtual machines or physical machines.

At block 1310, the method can receive subsequent input data and generate corresponding subsequent output data utilizing the surrogate model.

FIG. 14 relates to method 1400. At block 1402, the method can obtain input data relating to a physical system.

At block 1404, the method can partition tensors of a neural network across multiple processors. The multiple processors can be in a single computing device. Alternatively, the tensors can be spread across processors of multiple computing devices so that the neural network spans multiple virtual and/or physical devices.

At block 1406, the method can distribute the input data across multiple parallel cloud processing resources for numerical simulations involving a partial differential equation to produce corresponding output data. The multiple parallel cloud processing resources of block 1406 may include the multiple processors of block 1404 in whole or in part. Alternatively, the multiple parallel cloud processing resources of block 1406 may be separate and distinct from the multiple processors of block 1404.

At block 1408, the method can train the neural network across the tensors of the multiple processors with the input data and the output data to produce a surrogate model of the partial differential equation.

At block 1410, the method can receive subsequent input data and generate corresponding subsequent output data utilizing the surrogate model. For instance, the surrogate model may be stored in a library with other surrogate models relating to other physical systems. When subsequent input data is received that relates to an individual physical system, the corresponding surrogate model can be retrieved from the library, loaded in memory and employed to produce the corresponding subsequent output data.

The order in which the disclosed methods are described is not intended to be construed as a limitation, and any number of the described acts can be combined in any order to implement the method, or an alternate method. Furthermore, the methods can be implemented in any suitable hardware, software, firmware, or combination thereof, such that a computing device can implement the method. In one case, the methods are stored on one or more computer-readable storage media as a set of instructions such that execution by a processor of a computing device causes the computing device to perform the method.

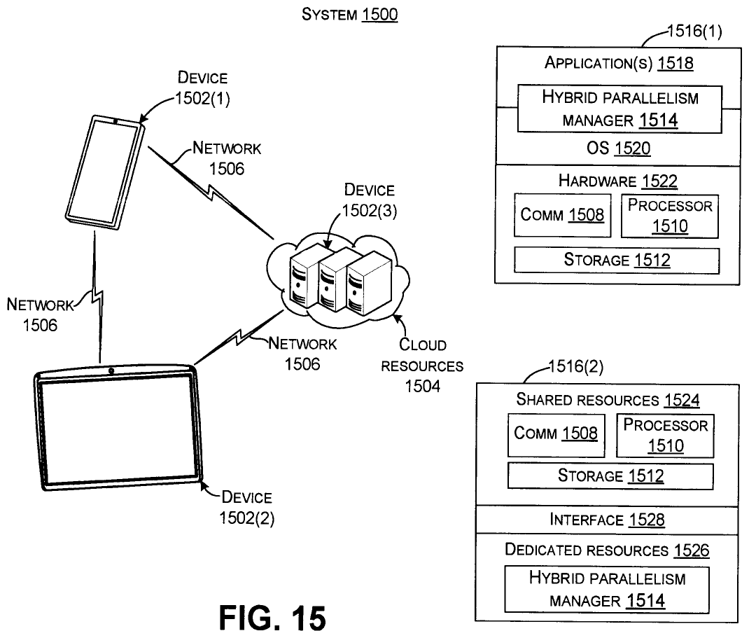

FIG. 15 shows an example system 1500. System 1500 can include computing devices 1502. In the illustrated configuration, computing device 1502(1) is manifest as a smartphone, computing device 1502(2) is manifest as a tablet type device, and computing device 1502(3) is manifest as a server type computing device, such as may be found in a datacenter as a cloud resource 1504. Computing devices 1502 can be coupled via one or more networks 1506 that are represented by lightning bolts.

Computing devices 1502 can include a communication component 1508, a processor 1510, storage resources (e.g., storage) 1512, and/or hybrid parallelism manager 1514.

The hybrid parallelism manager 1514 can manage simulation of initial input data to generate output data. The hybrid parallelism manager 1514 can manage the data parallelism of the input and output data and the model parallelism when training the model with the input and output data to produce the trained surrogate model. The hybrid parallelism manager 1514 can manage the use of the trained surrogate models, such as in the data library so that when further input data is received output data can be generated with the trained surrogate model rather than further simulations. Part of the management offered by the hybrid parallelism manager 1514 can be generation of graphical user interfaces (GUIs). One function of the GUIs can be to allow input data from a physical system to be paired with a trained surrogate model so that compute resources can be assigned to producing corresponding output data from the trained surrogate model. For instance, the hybrid parallelism manager 1514 could generate a GUI into which a user specifies a type of physical system they want to model. The user can provide their input data into the GUI, such as a via a link. The hybrid parallelism manager 1514 can select the corresponding trained model from the trained surrogate model library and cause the corresponding trained model to generate the corresponding output data.

The hybrid parallelism manager 1514 may occur on the same computing device(s) that performs the simulation and/or the model training or may occur on a different computing device and communicate with other computing devices, such as device 1502(3) over network 1506. For instance, the hybrid parallelism manager 1514 could occur on computing device 1502(1) or 1502(2) while the simulation and/or training occur on the cloud resources 1504. One function of the hybrid parallelism manager 1514 is to facilitate obtaining output data for input data of physical systems. The hybrid parallelism manager 1514 can achieve this functionality by generating GUls, providing APIs, such as the Redwood API, etc. to facilitate connecting input data with the computing resources to simulate output data. The hybrid parallelism manager 1514 can train the model with the input and output data. The hybrid parallelism manager 1514 can then use the trained model to obtain output data for subsequent input data.

FIG. 15 shows two device configurations 1516 that can be employed by computing devices 1502. Individual computing devices 1502 can employ either of configurations 1516(1) or 1516(2), or an alternate configuration. (Due to space constraints on the drawing page, one instance of each configuration is illustrated). Briefly, device configuration 1516(1) represents an operating system (OS) centric configuration. Device configuration 1516(2) represents a system on a chip (SOC) configuration. Device configuration 1516(1) is organized into one or more applications 1518, operating system 1520, and hardware 1522. Device configuration 1516(2) is organized into shared resources 1524, dedicated resources 1526, and an interface 1528 therebetween.

In configuration 1516(1), the hybrid parallelism manager 1514 can be manifest as part of the operating system 1520. Alternatively, the hybrid parallelism manager 1514 can be manifest as part of the applications 1518 that operate in conjunction with the operating system 1520 and/or processor 1510. In configuration 1516(2), the hybrid parallelism manager 1514 can be manifest as part of the processor 1510 or a dedicated resource 1526 that operates cooperatively with the processor 1510.

In some configurations, each of computing devices 1502 can have an instance of the hybrid parallelism manager 1514. However, the functionalities that can be performed by the hybrid parallelism manager 1514 may be the same or they may be different from one another when comparing computing devices. For instance, in some cases, each hybrid parallelism manager 1514 can be robust and provide all of the functionality described above and below (e.g., a device-centric implementation). In other cases, some devices can employ a less robust instance of the hybrid parallelism manager 1514 that relies on some functionality to be performed by a hybrid parallelism manager 1514 on another device.

The term “device,” “computer,” or “computing device” as used herein can mean any type of device that has some amount of processing capability and/or storage capability. Processing capability can be provided by one or more processors that can execute data in the form of computer-readable instructions to provide a functionality. Data, such as computer-readable instructions and/or user-related data, can be stored on storage, such as storage that can be internal or external to the device. The storage can include any one or more of volatile or non-volatile memory, hard drives, flash storage devices, and/or optical storage devices (e.g., CDs, DVDs etc.), remote storage (e.g., cloud-based storage), among others. As used herein, the term “computer-readable media” can include signals. In contrast, the term “computer-readable storage media” excludes signals. Computer-readable storage media includes “computer-readable storage devices.” Examples of computer-readable storage devices include volatile storage media, such as RAM, and non-volatile storage media, such as hard drives, optical discs, and flash memory, among others.

As mentioned above, device configuration 1516(2) can be thought of as a system on a chip (SOC) type design. In such a case, functionality provided by the device can be integrated on a single SOC or multiple coupled SOCs. One or more processors 1510 can be configured to coordinate with shared resources 1524, such as storage 1512, etc., and/or one or more dedicated resources 1526, such as hardware blocks configured to perform certain specific functionality. Thus, the term “processor” as used herein can also refer to central processing units (CPUs), graphical processing units (GPUs), field programable gate arrays (FPGAs), controllers, microcontrollers, processor cores, hardware processing units, or other types of processing devices.

Generally, any of the functions described herein can be implemented using software, firmware, hardware (e.g., fixed-logic circuitry), or a combination of these implementations. The term “component” as used herein generally represents software, firmware, hardware, whole devices or networks, or a combination thereof. In the case of a software implementation, for instance, these may represent program code that performs specified tasks when executed on a processor (e.g., CPU, CPUs, GPU or GPUs). The program code can be stored in one or more computer-readable memory devices, such as computer-readable storage media. The features and techniques of the components are platform-independent, meaning that they may be implemented on a variety of commercial computing platforms having a variety of processing configurations.

### CONCLUSION

The description includes simulations on large amounts of input data with PDEs to obtain corresponding output data. This input and output data functions as training data for training a model. Model and data parallelism are used to train the model with the training data.

Subsequent input data can be run through the model to obtain output data rather than repeating the simulation.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and other features and acts that would be recognized by one skilled in the art are intended to be within the scope of the claims.

### ADDITIONAL EXAMPLES

Various examples are described above. Additional examples are described below. One example includes a method comprising obtaining input data relating to a physical system, partitioning tensors of a neural network across multiple processors, distributing the input data across multiple parallel cloud processing resources for numerical simulations involving a partial differential equation to produce corresponding output data, training the neural network across the tensors of the multiple processors with the input data and the output data to produce a surrogate model of the partial differential equation, and receiving subsequent input data and generating corresponding subsequent output data utilizing the surrogate model.

Another example can include any of the above and/or below examples where partitioning tensors of a neural network across multiple processors comprises partitioning the tensors across multiple graphics processing units (GPUs), or wherein partitioning tensors of a neural network across multiple processors comprises partitioning the tensors across multiple deep learning processors or tensor processing units.

Another example can include any of the above and/or below examples where distributing the input data across multiple parallel cloud processing resources comprises distributing the input data across multiple virtual machines or physical machines.

Another example includes a device comprising a communication component configured to communicate with other computing resources and a hybrid parallelism manager configured to obtain input data relating to a physical system, simulate the physical system by employing a partial differential equation on the other computing resources to produce corresponding output data, partition tensors of a neural network across multiple parallel processors of the other computing resources, distribute the input data and the corresponding output data across the multiple parallel processors to train the neural network across the tensors of the multiple parallel processors with the input data and the corresponding output data to produce a trained surrogate model of the partial differential equation, and receive subsequent input data and generate subsequent corresponding output data utilizing the trained surrogate model.

Another example can include any of the above and/or below examples where the hybrid parallelism manager includes an application program interface (API) for distributing the input data and the corresponding output data across the multiple parallel processors.

Another example can include any of the above and/or below examples where the hybrid parallelism manager is configured to store the trained surrogate model in a library that includes trained surrogate models relating to various physical systems.

Another example can include any of the above and/or below examples where the hybrid parallelism manager is configured to generate a graphical user interface through which further input data relating to an individual physical system can be paired with an individual trained surrogate model in the library.

Another example can include any of the above and/or below examples where the hybrid parallelism manager is configured to cause the further input data to be run on the individual trained surrogate model to produce corresponding further output data.

Another example includes a system comprising a hardware processing unit and a storage resource storing computer-readable instructions which, when executed by the hardware processing unit, cause the hardware processing unit to obtain input data relating to a physical system, partition tensors of a neural network across multiple parallel processors, distribute the input data across multiple parallel processing resources for numerical simulations involving a partial differential equation to produce corresponding output data, train the neural network across the tensors of the multiple parallel processors with the input data and the corresponding output data to produce a surrogate model of the partial differential equation, and receive subsequent input data and generate corresponding subsequent output data utilizing the surrogate model without performing additional numerical simulations on the subsequent input data.

Another example can include any of the above and/or below examples where the hardware processing unit is further configured to cause the surrogate model to be stored in a library.

Another example can include any of the above and/or below examples where the library comprises a registry stored on a cloud object storage component configured for storing unstructured data.

Another example can include any of the above and/or below examples where the hardware processing unit is further configured to receive additional input data relating to the physical system that has different PDE coefficients that reflect material parameters of the physical system.

Another example can include any of the above and/or below examples where the hardware processing unit is configured to retrieve the surrogate model from the library and to generate additional output data from the surrogate model that reflects the different PDE coefficients.

Another example can include any of the above and/or below examples where the hardware processing unit comprises a central processing unit.

Another example can include any of the above and/or below examples where the multiple parallel processing resources include the central processing unit or wherein the central processing unit is located on different processing resources.

Another example can include any of the above and/or below examples where the multiple parallel processing resources include the multiple processors.

Another example can include any of the above and/or below examples where the multiple processors comprise multiple processors on a single physical computing device or wherein the multiple processors span multiple physical computing devices.

Another example can include any of the above and/or below examples where the multiple processors comprise multiple processors on a single virtual machine or wherein the multiple processors span multiple virtual machines.

Another example can include any of the above and/or below examples where the multiple parallel processing resources include the multiple processors, or wherein the multiple parallel processing resources are distinct from the multiple processors.

Another example can include any of the above and/or below examples where the system includes the multiple parallel processing resources and the multiple processors, or wherein the system communicates with the multiple parallel processing resources and the multiple processors.

Another example can include any of the above and/or below examples where the partial differential equation comprises a single partial differential equation or where the partial differential equation comprises multiple partial differential equations.

1. A method comprising:
obtaining input data relating to a physical system;
partitioning tensors of a neural network across multiple processors;
distributing the input data across multiple parallel cloud processing resources for numerical simulations involving a partial differential equation to produce corresponding output data;
training the neural network across the tensors of the multiple processors with the input data and the corresponding output data to produce a surrogate model of the partial differential equation; and,
receiving subsequent input data and generating corresponding subsequent output data utilizing the surrogate model.

2. The method of claim 1, wherein partitioning tensors of a neural network across multiple processors comprises partitioning the tensors across multiple graphics processing units (GPUs), or wherein partitioning tensors of a neural network across multiple processors comprises partitioning the tensors across multiple deep learning processors or tensor processing units.

3. The method of claim 1, wherein distributing the input data across multiple parallel cloud processing resources comprises distributing the input data across multiple virtual machines or physical machines.

4. A device comprising:
a communication component configured to communicate with other computing resources;
a hybrid parallelism manager configured to:
obtain input data relating to a physical system;
simulate the physical system by employing partial differential equations on the other computing resources to produce corresponding output data;
partition tensors of a neural network across multiple parallel processors of the other computing resources;
distribute the input data and the corresponding output data across the multiple parallel processors to train the neural network across the tensors of the multiple parallel processors with the input data and the corresponding output data to produce a trained surrogate model of the partial differential equations; and,
receive subsequent input data and generate corresponding subsequent output data utilizing the trained surrogate model.

5. The device of claim 4, wherein the hybrid parallelism manager includes an application program interface (API) for distributing the input data and the corresponding output data across the multiple parallel processors.

6. The device of claim 5, wherein the hybrid parallelism manager is configured to store the trained surrogate model in a library that includes trained surrogate models relating to various physical systems.

7. The device of claim 6, wherein the hybrid parallelism manager is configured to generate a graphical user interface through which further input data relating to an individual physical system can be paired with an individual trained surrogate model in the library.

8. The device of claim 7, wherein the hybrid parallelism manager is configured to cause the further input data to be run on the individual trained surrogate model to produce corresponding further output data.

9. A system comprising:
a hardware processing unit; and
a storage resource storing computer-readable instructions which, when executed by the hardware processing unit, cause the hardware processing unit to:
obtain input data relating to a physical system;
partition tensors of a neural network across multiple parallel processors;
distribute the input data across multiple parallel processing resources for numerical simulations involving partial differential equations to produce corresponding output data;
train the neural network across the tensors of the multiple parallel processors with the input data and the corresponding output data to produce a surrogate model of the partial differential equations; and,
receive subsequent input data and generate corresponding subsequent output data utilizing the surrogate model without performing additional numerical simulations on the subsequent input data.

10. The system of claim 9, wherein the hardware processing unit is further configured to cause the surrogate model to be stored in a library.

11. The system of claim 10, wherein the library comprises a registry stored on a cloud object storage component configured for storing unstructured data.

12. The system of claim 11, wherein the hardware processing unit is further configured to receive additional input data relating to the physical system that has different partial differential equation (PDE) coefficients that reflect material parameters of the physical system.

13. The system of claim 12, wherein the hardware processing unit is configured to retrieve the surrogate model from the library and to generate additional output data from the surrogate model that reflects the different PDE coefficients.

14. The system of claim 9, wherein the hardware processing unit comprises a central processing unit.

15. The system of claim 14, wherein the multiple parallel processing resources include the central processing unit or wherein the central processing unit is located on different processing resources.

16. The system of claim 9, wherein the multiple parallel processing resources include the multiple processors.

17. The system of claim 16, wherein the multiple processors comprise multiple processors on a single physical computing device or wherein the multiple processors span multiple physical computing devices.

18. The system of claim 16, wherein the multiple processors comprise multiple processors on a single virtual machine or wherein the multiple processors span multiple virtual machines.

19. The system of claim 9, wherein the multiple parallel processing resources include the multiple processors, or wherein the multiple parallel processing resources are distinct from the multiple processors.

20. The system of claim 9, wherein the system includes the multiple parallel processing resources and the multiple processors, or wherein the system communicates with the multiple parallel processing resources and the multiple processors.
